(19) United States
(12) Patent Application Publication
(10) Pub. No.: US 2025/0039996 A1
(43) Pub. Date: Jan. 30, 2025

(54) FLEXIBLE HEATING FILM AND WARMING PLATE

(71) Applicant: Tanjing Keji (Guangdong) Co. Ltd, Guangzhou (CN)

(72) Inventors: Bin HOU, Guangzhou (CN); Sheng LI, Guangzhou (CN)

(73) Assignee: Tanjing Keji (Guangdong) Co. Ltd, Guangzhou (CN)

(21) Appl. No.: 18/679,326

(22) Filed: May 30, 2024

(30) Foreign Application Priority Data
Jul. 24, 2023 (CN) 2023219486868

(51) Int. Cl. H05B 3/34

(52) U.S. Cl. CPC H05B 3/34

(57) ABSTRACT

The utility model relates to the electric heating, specifically to a flexible heating film and a vegetable warming plate. The flexible heating film heats up the flexible heating body after being energized through a conductive member, the first and the second electrode. The heating film is very flexible that are convenient to be rolled up or stored. The flexible insulator is heat-pressed and wrapped in the flexible heat-generating body, the first electrode and second electrode in membrane form, so that the flexible heat-generating film is waterproofing, insulating, and heat-generating. The warming plate is mainly composed of flexible heating film, so that it is flexible, easy to be stored or to rolled up, with small size, light weight and low production costs, high heating efficiency, excellent stability and heating uniformity, and being waterproof. It is excellent in insulation, being able to be connected to a wide range of adaptable voltage.

### CROSS-REFERENCE TO RELATED APPLICATIONS

The application claims priority to Chinese patent application No. 2023219486868, filed on Jul. 24, 2023, the entire contents of which are incorporated herein by reference.

### TECHNICAL FIELD

The utility model relates to the technical field of electric heating, specifically to a flexible heating film and a warm vegetable plate.

### BACKGROUND

Electric heating technology has significant advantages of utilizing clean energy, high heat conversion efficiency, and convenient laying design, which is widely used in modern household appliances, construction, heating engineering, and decoration. In the electric heating technology, the heating material is essential for the technology.

As for the current technology, traditional heat generating materials include metal heating wires, etched circuit heating plates, carbon paste heating coatings, and graphene heating film layers. Among them, the metal heating wire is of wire heating type. Although the stability is relatively high, the heating efficiency is relatively low, with relatively high material cost. The application usually requires 220V voltage or high voltage, and is not applicable to the use of a large area. In addition, etched circuit heating plate belongs to the surface heating type, whose stability and heating efficiency is general, with relatively high material cost. Although it can be adapted to low voltage, it is only for small area use. In addition, the carbon paste heating coating belongs to the surface heating type. Although its heating efficiency is relatively high, the stability is relatively poor. It can be adapted to low voltage, but only for small area use. In addition, the graphene heating film layer belongs to the face heating type. Although its heating efficiency is relatively high and its heating uniformity is relatively good, its softness and safety are poor, and its material cost relatively high.

In addition, in the application of electric heating technology, the warming plate is a class of household appliances that are more widely used, especially in the cold winter, to keep the food at the optimal serving temperature all the time.

At present, as for the current vegetable warming board, the heating material used is usually a metal heating wire. Such vegetable warming board generally is composed of a metal panel, a metal heating wire provided on the bottom surface of the metal panel, an insulating material layer affixed to the lower part of the metal heating wire, and an insulating material layer also provided on the upper surface of the metal panel. This kind of vegetable warming board has the defect of low heating efficiency due to the use of metal heating wire as the heating material. As the metal heating wire belongs to the wire heating type, the heating uniformity is not good. Moreover, the volume of such vegetable warming board is relatively large, and the production cost is relatively high.

In addition, since the cost of the etched circuit heating plate is relatively high and the stability is general, it is not suitable to be applied to the vegetable warming plate. The carbon paste heating coating has relatively poor stability and is also unsuitable for application to a vegetable warming plate. The graphene heating film layer is also unsuitable for application to the vegetable warming board because the production cost of the graphene heating film layer is relatively high and the maintenance is relatively difficult, and the graphene heating film layer may contain a small amount of hazardous chemical substances that may affect people's health.

### SUMMARY

In order to overcome the deficiencies of the existing technology, the first object of the utility model is to provide a flexible heating film, which has the advantages of high heating efficiency, excellent stability, low production cost, and can realize heating at both low and high voltage.

The second object of the utility model is to provide a vegetable warming plate, which is flexible, small in size, low in production cost, and has the advantages of high heating efficiency, excellent stability, and desirable heating uniformity.

In order to realize the above first object of the utility model, the utility model adopts the following technical solution:

The utility model provides a flexible heat generating film, which comprises a flexible heat generating body, the first and second electrode printed or plated on the two end portions of the mentioned flexible heat generating body, a flexible insulator thermally pressed and wrapped around the mentioned flexible heat generating body, the first and second electrode, and a conductive member electrically connected to the mentioned first and second electrode.

The flexible heat generating film of the utility model enables the flexible heat generating body to generate heat after being energized by the conductive member, the first and the second electrode. As the flexible heat generating body and the flexible insulator are both flexible, the flexible heat generating film has a good flexibility. It is convenient to roll up the flexible heat generating film or stow it away, wherein the flexible heat generating body is in the form of a film and the size of the flexible heat generating body is smaller than that of the flexible insulator and thus is covered by the flexible insulator, and the flexible heat generating body is in the form of a film. The flexible heat generating body is in the form of a membrane, and the size of the flexible heat generating body is smaller than that of the flexible insulator and is thus well covered by the flexible insulator. Therefore, the flexible heat generating membrane has the advantages of being waterproof, insulating, and generating heat uniformly. Among them, the flexible heating film through the conductive parts can be accessed 5V˜220V voltage can be different voltages, can make the temperature range of the flexible heating film for 20° C.˜150° C., so it has the advantages of being adaptable to broad range of broad, which makes the production cost of the flexible heating film has a greater advantage.

Further, the mentioned electrically conductive member comprises a first conductor and a second conductor, the mentioned first conductor is connected to the mentioned first electrode and extends outside of the mentioned flexible insulator, and the mentioned second conductor is connected to the mentioned second electrode and extends outside of the mentioned flexible insulator; wherein the first conductor and the second conductor can be made of flexible FPC cords and the first conductor and the second conductor can be affixed to the end portions of the first electrode and the second electrode, respectively, by means of a conductive adhesive. Electrode and the end of the second electrode, and the ends of the first conductor and the second conductor extending outside of the flexible insulator may be used for soldering or connecting to other conductive members (e.g., plugs) via wire quick connectors.
or

Further, the mentioned conductive member comprises a wireless charging module, the mentioned wireless charging module being electrically connected to the mentioned first electrode and the mentioned second electrode, respectively, and encased inside the mentioned flexible insulator. Wherein the wireless charging module is capable of energizing the first electrode and the second electrode, which in turn causes the flexible heat generating body to heat up. The insulation and waterproof performance is excellent because the conductive member is the wireless charging module and the wireless charging module is completely encapsulated in the interior of the flexible insulator, which in turn makes the entire flexible heat generating film completely insulated and completely waterproof.

Further, the mentioned flexible insulator comprises a silicone insulator or a rubber insulator; wherein either the silicone insulator or the rubber insulator has excellent flexibility, sealing and insulating properties, and is easy to be processed by injection molding, extruding, and hot pressing, and thus is convenient to be used to encapsulate the flexible heat generating body. and/or

Further, the mentioned rubber insulator comprises a TPU insulator or a TPE insulator. Wherein the TPU insulator is a thermoplastic polyurethane elastomer, which has very good processing properties and is easy to carry out injection, extrusion and calendering processing operations, and thus is convenient to be used for wrapping the flexible heat generating body. Wherein the TPE insulator is a thermoplastic elastomer, also known as synthetic rubber or synthetic rubber, which has relatively good processing performance and can be processed by injection, extrusion, blow molding, calendering, etc., which in turn facilitates the use for wrapping the flexible heat generator.

Further, the mentioned flexible heat generator comprises a flexible substrate, and a conductive substance dispersed in the mentioned flexible substrate; wherein the conductive substance of the flexible heat generator is dispersed in the flexible substrate, which enables the flexible heat generator to be electrically conductive as a whole for generating heat. Due to the flexible substrate being used as an overall support body, it in turn enables the flexible heat generator to be very good in flexibility, and rollability. and/or

Further, the mentioned flexible substrate comprises a thermoplastic elastomer; wherein the thermoplastic elastomer not only has high elasticity, but also has excellent flexibility and processing properties, and can be processed by injection molding, extrusion, blow molding, calendering, and other processing, and thus facilitating the preparation of the flexible heat generating film. and/or

Further, the mentioned thermoplastic elastomer comprises one of TPU, TPE, or SBS; wherein the TPU is a thermoplastic polyurethane elastomer with excellent processing properties, easily to be processed operations such as injection, extrusion, and calendering, and thus facilitating the preparation of the flexible heat generating film. The TPE is a thermoplastic elastomer, also known as artificial rubber or synthetic rubber, which has relatively good processing performance, and can be processed by injection molding, extrusion, blow molding, calendering and other processing operations. It in turn facilitates the preparation of the flexible heat generating film. The SBS is a styrene-butadiene-styrene block copolymer that can be processed such as extrusion, injection, blow molding, calendering and the like, which in turn facilitates the preparation of the flexible heat generating film. and/or

Further, the mentioned conductive substance comprises carbon nanotubes, graphene or conductive carbon black. Wherein the carbon nanotubes, graphene or conductive carbon black have good conductive properties and are easy to be uniformly dispersed in the flexible substrate, thereby enabling the flexible heat generating body to be conductive as a whole and uniformly heat generating, and enabling the flexible heat generating film to have excellent heat generating uniformity.

Further, the mentioned first and second electrode are provided in parallel with each other, thereby making the current from the first electrode or the second electrode reach the second electrode or the first electrode through the flexible heat generating body, enabling the current to comprehensively pass through all the area of the flexible heat generating body between the first electrode and the second electrode, thereby making the flexible heat generating body conduct electricity uniformly and generate heat uniformly, and thus further improving the heating uniformity of the flexible heat generating film. The heating uniformity of the flexible heating film is thus further improved.

Further, the mentioned flexible heat generator has a thickness of 0.2 mm to 1.0 mm; which. ensures good conductive heat generating performance and softness of the flexible heat generating film, ensuring that the flexible heat generating film can be bent arbitrarily. and/or

Further, the mentioned flexible heat generating film has a thickness of 0.4 mm to 3 mm, which can ensure a very good softness and can be bent arbitrarily.

In order to realize the second object of the above utility model, the technical solution. adopted is as follows:

The present utility model provides a warm vegetable plate, including a flexible heat. generating film as described above.

The utility model provides a vegetable warming plate, as the main component is a flexible heating film as described above, relative to a traditional vegetable warming plate, the utility model's vegetable warming plate is flexible, easy to be stored or conveniently rolled up and placed, has the advantages of small size, light weight and low production cost, and has the advantages of high heating efficiency, excellent stability and good heating uniformity, and also has excellent waterproofing and insulating properties.

Further, the mentioned warming plate further comprises a plug being electrically connected to the mentioned conductive member; wherein, the conductive member comprises the first and second conductor, with the first connected to the mentioned first electrode and extending outside of the mentioned flexible insulator, and the mentioned second conductor connected to the mentioned second electrode and extending outside of the mentioned flexible insulator. The first and the second wire extending outside the flexible insulator are connected to the plug through welding or wire quick connector. Among them, it can be connected to 5V˜220V voltage through the plug. When connected to different voltages, the temperature range of the warming plate ranges from 20° C. to 150° C., so it has the advantage of adapting to a wide range of voltages. Therefore, it has greater cost advantage for production.
or

Further, the mentioned vegetable warming plate further comprises a wireless charging base. When the conductive member is a wireless charging module, it is completely encapsulated inside the flexible insulator and electrically connected to the first and the second electrode by electrically connecting with the first and the second electrode, which in turn causes the flexible heating body to conduct electricity and generate heat. When the warming plate is in use, the whole or part of the flexible heating film is placed on the wireless charging base that is provided with a plug, so that the plug can be connected to a voltage of 5V to 220V, which in turn causes the flexible heating body to conduct electricity and generate heat through the wireless charging module in the interior of the flexible insulator. In addition, since the vegetable warming plate adopts the wireless charging method, the insulation and waterproof performance of the vegetable warming plate are desirable.

Further, the mentioned vegetable warming board further comprises a temperature control panel connected to a temperature control probe, which is disposed on the bottom surface of the mentioned flexible heat generating film, or the mentioned temperature control probe being connected with the mentioned flexible heat generating body and extending outside the mentioned flexible insulator;

When the mentioned conductive member comprises a first conductor and a second conductor, the mentioned first and the second conductor are electrically connected to the mentioned temperature control panel that is electrically connected to the mentioned plug by wire; or

When the mentioned conductive member includes a wireless charging module, the mentioned temperature control panel is provided on the mentioned wireless charging base and electrically connected to the mentioned wireless charging base by wires;

Wherein, by setting the temperature control panel, it is possible to conveniently adjust the desired temperature of the warming plate, which in turn is able to realize the staged

wherein the temperature control panel enables easy adjustment of the desired temperature of the warming plate, and thus enables staged temperature control. For example, when connected to a 220V voltage, the temperature control panel enables adjustment of the voltage or the duty cycle, and thus adjusts the temperature of the warming plate.
and/or

Further, the mentioned temperature control panel is provided with an over-temperature controller that is in contact with the mentioned flexible heating film. The over-temperature controller is used to sense the temperature of the warming plate. Once the temperature of the warming plate exceeds the temperature to be adjusted, the temperature control panel controls the warming plate to stop energizing and heating. The heating is re-energized when the temperature drops.

Further, the mentioned vegetable warming board further comprises a temperature display screen that is provided on an upper surface of the mentioned temperature control panel; the mentioned temperature display screen being electrically connected to the mentioned temperature control panel. Therein, the setting of the temperature display screen enables one to conveniently know the temperature of the vegetable warming board and make adjustments as needed.

Compared with the prior technology, the beneficial effects of the utility model are:
(1) The utility model is a flexible heating film. When the conductive member, the first and the second electrode are energized, the flexible heating body is heating. The flexible heating body and the flexible insulator are flexible, so that the flexible heating film has a very good flexibility, easy to get rolled up or stored. The flexible heat generating body is in the form of a membrane, the size of which is smaller than that of the flexible insulator and is thus well covered by the flexible insulator. Therefore, the flexible heat generating membrane has the advantages of being waterproof, insulating, and generating heat evenly.
(2) The utility model of a flexible heating film, can be connected to 5V˜220V voltage through the conductive member. With different voltages, the flexible heating film can be heat up in temperature range of 20° C.˜150° C., thus being able to be adaptable to broad voltage. Therefore, it has a greater advantage in the production cost of the flexible heating film.
(3) As for the utility model of a vegetable warming plate, the main component is a flexible heating film as described above. Compared with the traditional vegetable warming plate, the utility model of the vegetable warming plate is flexible, easy to store or conveniently rolled up and placed, with the advantages of small volume, light weight and low production cost, high heating efficiency, excellent stability, and good heating uniformity, waterproofing and insulating properties.
(4) The utility model of a warming plate can be connected to the 5V˜220V voltage through the plug or wireless charging seat. With different voltages, the flexible heating film can be heat up in temperature range of 20° C.˜150° C., thus being able to be adaptable to broad voltage. Therefore, it has a greater advantage in the production cost of the flexible heating film.
(5) The utility model of a warming plate has a simple structure, high production efficiency, low production cost, and can be suitable for mass production.

### BRIEF DESCRIPTION OF DRAWINGS

In order to more clearly illustrate the technical solutions in the examples of the utility model, the attached drawings that need to be used in the example description of the current technology will be briefly introduced below. It will be obvious that the attached drawings in the following description are only some examples of the utility model. Despite of the need for creative labor, the technical staff in this field can obtain other drawings based on these.

FIG. 1 is a schematic diagram of a cross-sectional structure of a flexible heat generating film of the present utility model.

FIG. 2 is a schematic structural diagram of a flexible heat generating film of the present utility model in Example 1

FIG. 3 is a schematic diagram of a decomposed structure of a flexible heat generating film of the present utility model in Example 1.

FIG. 4 is a schematic diagram of the decomposed structure of a flexible heat generating film of the present utility model in Example 2.

FIG. 5 is a schematic diagram of the structure of a warm vegetable plate of the present utility model in Example 3.

FIG. 6 is a schematic diagram of the structure of a warm vegetable board of the present utility model in Example 4.

FIG. 7 is a schematic diagram of a decomposed structure of a warming vegetable board of the present utility model in Example 5.

FIG. 8 is a schematic diagram of the disassembled structure of a warming vegetable board of the present utility model in Example 6.

FIG. 9 is a schematic diagram of a conventional metal heating wire and its heat generation after being energized, in which the left figure is a conventional metal heating wire and the right is a schematic diagram of the heat generation after being energized by the conventional metal heating wire.

FIG. 10 is a schematic diagram of the flexible heating film of the utility model and its heat generation after being energized in Example 1, in which the left figure is the flexible heating film and the right figure is the schematic diagram of the flexible heating film after being energized.

In the figure: flexible heat generating body 1; first electrode 2; second electrode 3; flexible insulator 4; first wire 5; second wire 6; plug 7; wireless charging base 8; wireless charging module 9; temperature control panel 10; temperature display.

### DETAILED DESCRIPTION OF THE EMBODIMENTS

In order to make clearer of the technical problems, technical solutions and beneficial effects to be solved by the present utility model, the present utility model is described in further detail below in combination with examples. It should be understood that the specific examples described herein are only for explaining the present utility model, which are not intended to limit the present utility model.

Terms used in the examples of the utility model are used for the sole purpose of describing particular examples and are not intended to limit the utility model. In the present invention, the singular forms of “a”, “the mentioned”, and “the” used in the examples and appended claims are also intended to encompass the majority form, unless the context clearly indicates otherwise. other meanings.

Wherein the TPU referred to in the present utility model is a thermoplastic polyurethane elastomer, and the TPU is a polymer material made by reactive polymerization of diphenylmethane diisocyanate (MDI), toluene diisocyanate (TDI), and large polymer polyols, and chain extender.

Wherein the TPE referred to in the present utility model is a thermoplastic elastomer, also known as artificial rubber or synthetic rubber.

Wherein the SBS referred to in the present utility model is a styrene-butadiene-styrene block copolymer, which is capable of extrusion, injection, blow molding, calendering, and other processing and molding processes, which in turn facilitates the preparation of a flexible heating film.

The following is an illustration with specific examples.

### Example 1

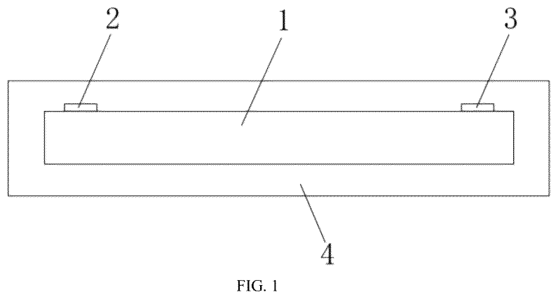

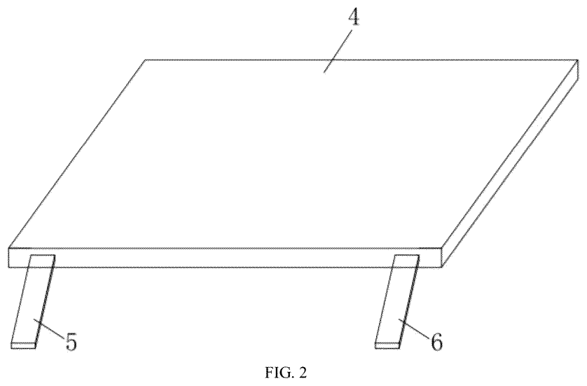

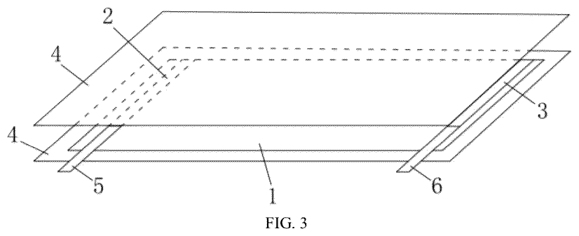

A flexible heating film of this example, as shown in FIGS. 1, 2 and 3, includes a flexible heating body 1, first electrodes 2 and second electrodes 3 printed or plated on the two end portions of the flexible heating body 1, a flexible insulator 4 thermally pressed to encapsulate the flexible heating body 1, the first electrodes 2 and the second electrodes 3, and an electrically conductive member electrically connected to the first electrodes 2 and the second electrodes 3.

In this example, the electrically conductive member includes a first conductor 5 and a second conductor 6, the first conductor 5 is connected to the first electrode 2 and extends outside of the flexible insulator 4, and the second conductor 6 is connected to the second electrode 3 and extends outside of the flexible insulator 4; wherein the first conductor 5 and the second conductor 6 can be made of flexible FPC cords and are pasted by a conductive adhesive to the first conductor 5 and the second conductor 6 on the ends of the first electrode 2 and the second electrode 3, respectively. The first conductor 5 and the second conductor 6 may be used as flexible FPC wires, and the first conductor 5 and the second conductor 6 are pasted onto the ends of the first electrode 2 and the second electrode 3, respectively, by a conductive adhesive, and the ends of the first conductor 5 and the second conductor 6 extending outside the flexible insulator 4 may be used for soldering or connecting to other electrically conductive parts (e.g., plugs) by means of a quick connector for wires.

In this example, the flexible insulator 4 comprises a silicone insulator or a rubber insulator; wherein the silicone insulator or the rubber insulator are both highly flexible, airtight and insulating, and are easy to be injection molded, extruded and hot pressed, which in turn is convenient to be used for wrapping the flexible heat generator 1.

In this example, the rubber insulator includes a TPU insulator or a TPE insulator. The TPU insulator is a thermoplastic polyurethane elastomer, which has very good processing properties and is easy to be processed by injection, extrusion, and calendering, and thus is convenient to be used for wrapping the flexible heat generating body 1. The TPE insulator is a thermoplastic elastomer, which is also known as synthetic rubber or synthetic rubber, which has better processing properties and is processed by injection, extrusion, blow molding, and calendering, and thus is convenient to be used for wrapping the flexible heat generating body 1.

In this example, the flexible heat generator 1 comprises a flexible substrate, and a conductive substance dispersed in the flexible substrate; wherein the conductive substance dispersed in the flexible substrate of the flexible heat generator 1 enables it to be electrically conductive and generate heat as a whole, and because the flexible substrate serves as an overall support body, the flexible heat generator 1 is very flexible and can be curled very well.

In this example, the flexible substrate comprises a thermoplastic elastomer; wherein the thermoplastic elastomer not only has high elasticity, but also has excellent flexibility and processing properties, which can be processed by injection molding, extrusion, blow molding, calendering, and so on, thus facilitating the preparation of the flexible heating film.

In this example, the thermoplastic elastomer includes one of TPU, TPE, or SBS; wherein the TPU is a thermoplastic polyurethane elastomer, which has excellent processing performance and is easy to be processed by injection, extrusion, and calendering, and thus facilitates the preparation of the flexible heating film. Wherein, the TPE is a thermoplastic elastomer, also known as artificial rubber or synthetic rubber, which has relatively good processing performance, and can be processed by injection molding, extrusion, blow molding, calendering and other processing operations, which in turn facilitates the preparation of the flexible heat generating film. Wherein, the SBS is a styrene-butadiene-styrene block copolymer, which is capable of processing and molding processes such as extrusion, injection, blow molding, calendering, etc., which in turn facilitates the preparation of the flexible heating film.

In this example, the conductive substance comprises carbon nanotubes, graphene, or conductive carbon black. Among them, the carbon nanotubes, graphene, or conductive carbon black have good electrical conductivity, and are easy to be uniformly dispersed in the flexible substrate, thereby making the flexible heating body 1 capable of conducting electricity as a whole and generating heat uniformly, and making the heating uniformity of the flexible heating film excellent.

In this example, the first electrode 2 and the second electrode 3 are provided in parallel with each other, which enables the current from the first electrode 2 or the second electrode 3 to reach the second electrode 3 or the first electrode 2 via the flexible heat generating body 1, and enables the current to pass through all areas of the flexible heat generating body 1 between the first electrode 2 and the second electrode 3. It thus ensures the flexible heat generating body 1 to conduct electricity uniformly and generate heat uniformly, and therefore further improves the heat generating uniformity of the flexible heat generating film. The heating uniformity of the flexible heating film is further improved.

In this example, the thickness of the flexible heat generating body 1 ranges. from 0.2 mm to 1.0 mm; the flexible heat generating body 1 of this thickness ensures both a very good conductive heat generating performance, a good softness of the flexible heat generating film that can be bent arbitrarily.

In this example, the thickness of the flexible heat generating film is 0.4 mm to 3 mm. the flexible heat generating film of this thickness can ensure good flexibility and can be bent arbitrarily.

A flexible heat generating film of the present example makes the flexible heat generating body 1 heated by the first conductor 5, the second conductor 6, the first electrode 2 and the second electrode 3 after being energized, and since the flexible heat generating body 1 and the flexible insulator 4 are both flexible, thus making the flexible heat generating film have good flexibility, and it is convenient to roll up or stow away the flexible heat generating film, wherein the flexible heat generating body 1 is in the form of a film and the wherein the flexible heat generating body 1 is in the form of a membrane, and the size of the flexible heat generating body 1 is smaller than the flexible insulator 4 and is well covered by the flexible insulator 4, so that the flexible heat generating film has the advantages of waterproofing, insulating, and generating heat uniformly. The utility model of a warming plate can be connected to the 5V˜220V voltage through conductive member. With different voltages, the flexible heating film can be heat up in temperature range of 20° C.˜150° C., thus being able to be adaptable to broad voltage. Therefore, it has a greater advantage in the production cost of the flexible heating film.

### Example 2

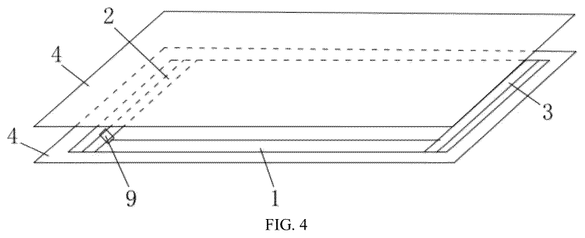

A flexible heat generating film of the present example, as shown in FIGS. 1 and 4, comprises a flexible heat generating body 1, first electrodes 2 and second electrodes 3 printed or plated on the two end portions of the flexible heat generating body 1, a flexible insulator 4 thermally pressed and wrapped around the flexible heat generating body 1, the first electrodes 2 and the second electrodes 3, and an electrically conductive member electrically connected to the first electrodes 2 and the second electrodes 3.

In this example, the conductive member comprises a wireless charging module 9, the wireless charging module 9 being electrically connected to the first electrode 2 and the second electrode 3, respectively, and encapsulated in the interior of the flexible insulator 4. Among other things, the wireless charging module 9 can cause the first electrode 2 and the second electrode 3 to be energized, which in turn causes the flexible heat generating body 1 to heat up. Since the conductive member is the wireless charging module 9 and the wireless charging module 9 is completely encapsulated in the interior of the flexible insulator 4, which in turn makes the entire flexible heat generating film completely insulated and completely waterproof, the insulating and waterproofing properties are excellent.

In this example, the flexible insulator 4 comprises a silicone insulator or a rubber insulator; wherein the silicone insulator or the rubber insulator are both highly flexible, airtight and insulating, and are easy to be injection molded, extruded, and hot-pressed, which in turn facilitates their use for wrapping the flexible heat generator 1.

In this example, the rubber insulator includes a TPU insulator or a TPE insulator. The TPU insulator is a thermoplastic polyurethane elastomer, which has very good processing properties and is easy to be processed by injection, extrusion, and calendering, and thus is convenient to be used for wrapping the flexible heat generating body 1. The TPE insulator is a thermoplastic elastomer, which is also known as synthetic rubber or synthetic rubber, which has better processing properties and is processed by injection, extrusion, blow molding, and calendering, and thus is convenient to be used for wrapping the flexible heat generating body 1. flexible heat generator 1.

In this example, the flexible heat generator 1 includes a flexible substrate, and a conductive substance dispersed in the flexible substrate; wherein the conductive substance dispersed in the flexible substrate of the flexible heat generator 1 enables the flexible heat generator 1 to be electrically conductive and generate heat as a whole, and because the flexible substrate serves as an overall support body, the flexible heat generator 1 is very pliable and can be curled very well.

In this example, the flexible substrate comprises a thermoplastic elastomer; wherein the thermoplastic elastomer not only has high elasticity, but also has excellent flexibility and processing properties, and can be processed by injection molding, extrusion, blow molding, calendering, and so on, thus facilitating the preparation of the flexible heating film.

In this example, the thermoplastic elastomer includes one of TPU, TPE, or SBS; wherein the TPU is a thermoplastic polyurethane elastomer, which has excellent processing performance and is easy to be processed by injection, extrusion, and calendering, and thus facilitates the preparation of the flexible heating film. Wherein, the TPE is a thermoplastic elastomer, also known as artificial rubber or synthetic rubber, which has relatively good processing performance, and can be processed by injection molding, extrusion, blow molding, calendering and other processing operations, which in turn facilitates the preparation of the flexible heat generating film. The SBS is a styrene-butadiene-styrene block copolymer, which is capable of processing and molding processes such as extrusion, injection, blow molding, calendering, etc., which in turn facilitates the preparation of the flexible heating film.

In this example, the conductive substance comprises carbon nanotubes, graphene, or conductive carbon black. Among them, the carbon nanotubes, graphene or conductive carbon black have good conductive properties, and are easy to be uniformly dispersed in the flexible substrate, which makes the flexible heat generating body 1 conductive as a whole and uniformly heat generating.

The flexible heat generating body 1 can conduct electricity and generate heat uniformly, and the flexible heat generating film has desirable heat generation uniformity.

In this example, the first electrode 2 and the second electrode 3 are provided in parallel with each other, thereby enabling the current to pass from the first electrode 2 or the second electrode 3 to the second electrode 3 or the first electrode 2 via the flexible heat generating body 1, the current pass through the flexible heat generating body 2 and the second electrode 3 in a comprehensive manner.

In the example, the first electrode 2 and the second electrode 3 are provided parallel to each other, so that when the current reaches the second electrode 3 or the first electrode 2 from the first electrode 2 or the second electrode 3, the current can fully pass through all the area of the flexible heat generating body 1 between the first electrode 2 and the second electrode 3, so that the flexible heat generating body 1 conducts electricity uniformly and generates heat uniformly, and the heat generating uniformity of the flexible heat generating film can be improved.

In this example, the thickness of the flexible heat generating body 1 is 0.2 mm to 1.0 mm; the flexible heat generating body 1 of this thickness ensures both a very good conductive heat generating performance and a very good softness of the flexible heat generating film to ensure that the flexible heat generating film can be bent at will.

In this example, the thickness of the flexible heat generating film is 0.4 mm to 3 mm. the flexible heat generating film of this thickness can ensure good flexibility and can be bent arbitrarily.

A flexible heat generating film of this example, the wireless charging module 9, the first electrode 2, and the second electrode 3 cause the flexible heat generating body 1 to generate heat after being energized, and because the flexible heat generating body 1 and the flexible insulator 4 are both flexible, the flexible heat generating film is made to have good flexibility, and it is convenient to roll up the flexible heat generating film or stow the flexible heat generating film, wherein the flexible heat generating body 1 is in the form of a film, and the flexible heat generating body wherein the flexible heat generating body 1 is in the form of a membrane, and the size of the flexible heat generating body 1 is smaller than the flexible insulator 4 and thus well covered by the flexible insulator 4, so that the flexible heat generating film has the advantages of waterproof, insulation, and uniform heat generation. Among them, the flexible heating film can be connected to the 5V˜220V voltage through the conductive parts. With different voltages, the flexible heating film can be heat up in temperature range of 20° C.˜150° C., thus being able to be adaptable to broad voltage. Therefore, it has in turn a greater advantage in the production cost of the flexible heating film.

### Example 3

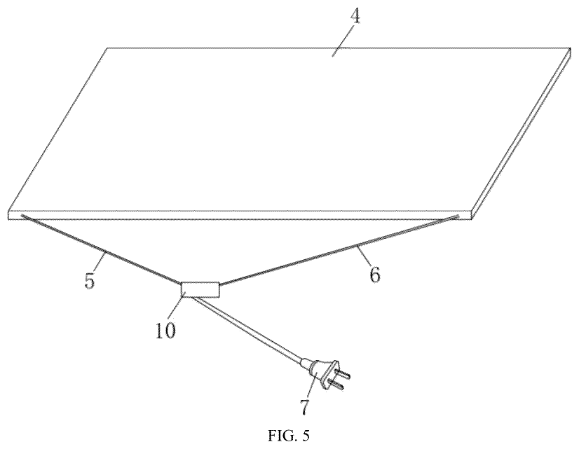

A warming plate of this example, as shown in FIG. 5, includes a flexible heating film of Example 1.

In this example, the vegetable warming board further comprises a plug 7, the plug 7 being electrically connected to a conductive member; wherein the conductive member of this example has a first conductor 5 and a second conductor 6, wherein the first conductor 5 is connected to a first electrode 2 and extends outside the flexible insulator 4, and the second conductor 6 is connected to a second electrode 3 and extends outside the flexible insulator 4, at which point the first conductor 5 and the second conductor 6 extending outside the flexible insulator 4 are connected by welding or wires. conductor 6 are connected to the plug 7 by soldering or a wire quick connector. Among them, the plug 7 can be connected to a voltage of 5V to 220V. When connected to different voltages, the warming plate can be heat up in the temperature range from 20° C. to 150° C. Therefore, it has the advantage of being adaptable to broad range of voltages, which in turn makes the production cost a greater advantage.

In this example, the warm vegetable board further includes a temperature control panel 10, the temperature control panel 10 is connected with a temperature control probe, the temperature control probe is set on the bottom surface of the desired heat generating film, or the temperature control probe is connected with the flexible heat generating body 1 and extends outside the flexible insulator 4; the first conductor 5 and the second conductor 6 are electrically connected to the temperature control panel 10, and the temperature control panel 10 is electrically connected to the plug 7 through the conductor; wherein, through the temperature control panel 10 is provided, it is possible to conveniently adjust the desired temperature of the vegetable warming board, and then it is possible to realize temperature control in stages, that is, when 220V voltage is accessed, the voltage or duty cycle can be adjusted through the temperature control panel 10, and then the temperature of the vegetable warming board can be adjusted.

In this example, the temperature control panel 10 is provided with an over-temperature controller, and the over-temperature controller is contacted with the flexible heating film. In this example, the temperature control panel 10 is provided with an over-temperature controller, which is contacted with the flexible heating film, wherein the over-temperature controller is used to sense the temperature of the warming plate, and once the temperature of the warming plate exceeds the temperature to be adjusted, the temperature control panel 10 controls the warming plate to stop being energized. The heating is re-energized when the temperature drops.

The utility model provides a vegetable warming plate, as the main component is a flexible heating film as described above, relative to a traditional vegetable warming plate, the utility model's vegetable warming plate is flexible, easy to be stored or conveniently rolled up and placed, has the advantages of small size, light weight and low production cost, and has the advantages of high heating efficiency, excellent stability and good heating uniformity, and also has excellent waterproofing and insulating properties.

### Example 4

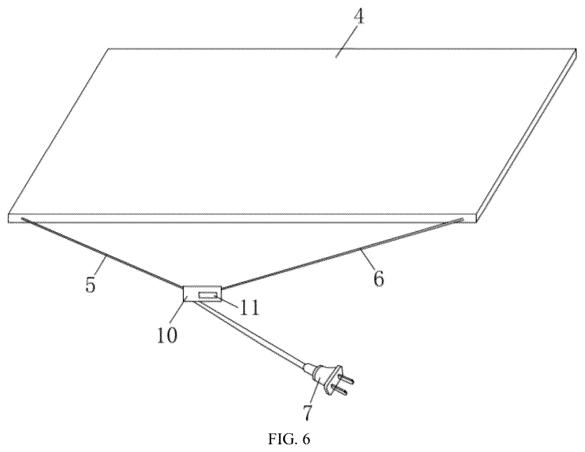

As for the warming plate of the present example, shown in FIG. 6, the present example is distinguished from Example 3 in that the warming plate further comprises a temperature display 11. The temperature display 11 is set on an upper surface of the temperature control panel 10; the temperature display 11 is electrically connected to the temperature control panel. In this example, the temperature display 11 is provided to enable people to easily know the temperature of the warming plate and make adjustments according to the needs. The rest of the technical solutions of this example are the same as that of Example 3.

The utility model provides a vegetable warming plate, as the main component is a flexible
heating film as described above, relative to a traditional vegetable warming plate, the utility model's vegetable warming plate is flexible, easy to be stored or conveniently rolled up and placed, has the advantages of small size, light weight and low production cost, and has the advantages of high heating efficiency, excellent stability and good heating uniformity, and also has excellent waterproofing and insulating properties.

### Example 5

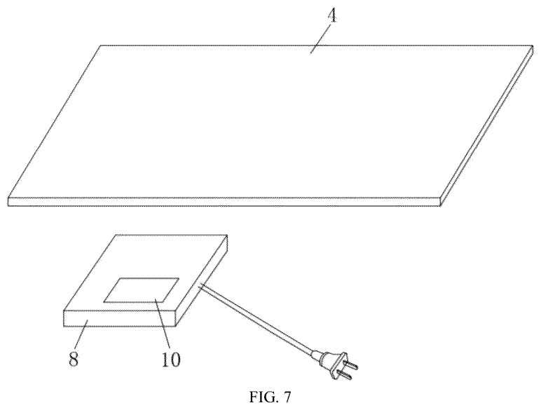

A warming plate of this example, as shown in FIG. 7, includes a flexible heating film of Example 2.

In this example, the warming board also includes a wireless charging base 8. In this example, when the conductive member is a wireless charging module 9, it is completely encapsulated in the interior of the flexible insulator 4, and electrically connected with the first electrode 2 and the second electrode 3, which in turn causes the flexible heating body 1 to conduct electricity and generate heat. When the warming plate is in use, the whole or part of the flexible heating film is placed on the wireless charging base 8, and the wireless charging base 8 is provided with a plug, which can be connected to a voltage of 5V to 220V through the plug. The wireless charging module 9 in the interior of the flexible insulator 4 makes the flexible heating body 1 electrically conductive and generates heat. In addition, the wireless charging method of the warming plate ensures it excellent insulating and waterproof performance.

In this example, the vegetable warming board also includes a temperature control panel 10 that is set on the wireless charging base 8 and connected to the wireless charging base 8 wire. The temperature control panel 10 is connected to a temperature control probe that is set on the bottom surface of the desired heating film, or the temperature control probe is connected to the flexible heat generating body 1 and extends outside the flexible insulator 4; wherein the temperature control panel is set up in such a way as to easily adjust the desired temperature of the warming board, thus being able to realize temperature control in different gears. When connecting to 220V voltage, the temperature control panel 10 can adjust the voltage or the duty cycle, so as to adjust the temperature

In this example, the temperature control panel 10 is provided with an ultra-temperature controller, and the ultra-temperature controller is contacted with the flexible heating film. Therein, the over-temperature controller is used to sense the temperature of the warming plate. When the temperature of the warming plate exceeds the temperature to be adjusted, the temperature control panel 10 controls the warming plate to stop energizing and heating. The heating is re-energized when the temperature drops.

The present example provides a warming plate, as the main component is a flexible heating film as described above, relative to a traditional vegetable warming plate, the utility model's vegetable warming plate is flexible, easy to be stored or conveniently rolled up and placed, has the advantages of small size, light weight and low production cost, and has the advantages of high heating efficiency, excellent stability and good heating uniformity, and also has excellent waterproofing and insulating properties.

### Example 6

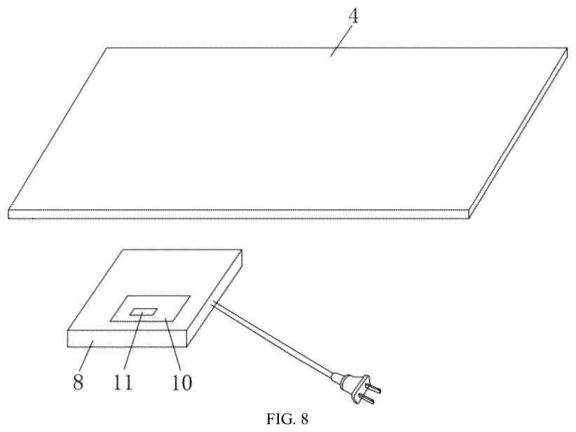

As for the warming plate of this example, shown in FIG. 8, the difference between this example and example 5 is that the warming plate further includes a temperature display 11, which is provided on an upper surface of the temperature control panel 10; the temperature display 11 is electrically connected to the temperature control panel 10. The temperature display 11 is electrically connected to the temperature control panel 10. In this example, the temperature display 11 enable people to see easily the temperature of the warming plate and make adjustments according to the needs. The rest of the technical solutions of this example are the same as that of Example 5.

The utility model provides a vegetable warming plate, as the main component is a flexible

heating film as described above, relative to a traditional vegetable warming plate, the utility model's vegetable warming plate is flexible, easy to be stored or conveniently rolled up and placed, has the advantages of small size, light weight and low production cost, and has the advantages of high heating efficiency, excellent stability and good heating uniformity, and also has excellent waterproofing and insulating properties.

### Experimental Tests

### (1) Heating Uniformity Test

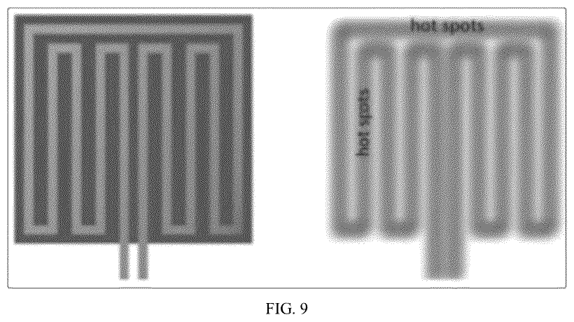

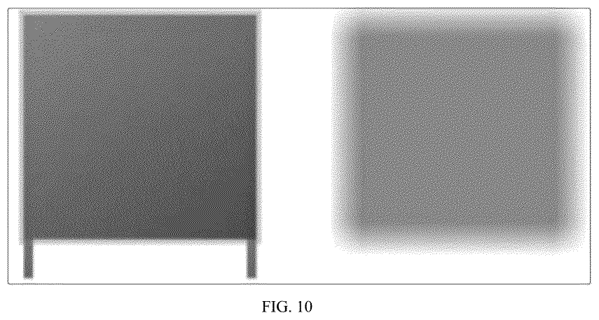

A flexible heating film made in Example 1 and a traditional warming plate were tested for heat generation uniformity using an infrared thermal imager. About the comparisons between the flexible heating film and the conventional warming board, please refer to FIG. 9 and FIG. 10, which shows that the flexible heating film of the utility model has a very good uniformity for heat generation. Therefore, in the utility model the flexible heating film applied to the prepared warming plate also has desirable heat generation uniformity.

### (2) Curl Test

A flexible heating film made in Example 1 was curled. The flexible heating film of the utility model has the advantages of toughness and curling.

The above is only a better example of the present application, and is not intended to limit the present application, and any modifications, equivalent substitutions and improvements made within the principles of the present application shall be included in the scope of protection of the present application.

What is claimed is:

1. The characterizations of the flexible heat generating film include a flexible heat generating body, the first and second electrode printed or plated on the two end portions of the mentioned flexible heat generating body, a flexible insulator thermally pressed and wrapped around the mentioned flexible heat generating body, the first and second electrode, and an electrically conductive member electrically connected to the first and the mentioned second electrode.

2. The characterizations of the flexible heat generating film in Item 1 of claims include that the mentioned conductive member comprises the first and second conductor, the mentioned first conductor being connected to the mentioned first electrode and extending outside the mentioned flexible insulator, and the mentioned second conductor being connected to the mentioned second electrode and extending outside the mentioned flexible insulator; or
the mentioned conductive member comprises a wireless charging module, with the mentioned wireless charging module being electrically connected to the mentioned first and second electrode, respectively, and encased within the mentioned flexible insulator.

3. The characterizations of the flexible heat generating film in Item 1 of claims include the mentioned first and second electrode provided parallel to each other.

4. The characterizations of the flexible heat generating film in Item 1 of claims include the mentioned flexible heat generating body with a thickness of 0.2 mm˜1.0 mm; and/or
the thickness of the mentioned flexible heat generating film is 0.4 mm to 3 mm.

5. The characterization of the vegetable warming plate is that it comprises a flexible heat generating film as stated in any one of Item 1 of claims.

6. The characterization of the vegetable warming plate stated in Item 5 of claims is that the mentioned vegetable warming board further comprises a plug, with the mentioned plug being electrically connected to the conductive member; or
the mentioned vegetable warming board further comprising a wireless charging base.

7. The characterization of the vegetable warming plate in Item 6 of claims is that the mentioned vegetable warming board further comprises a temperature control panel, with the mentioned temperature control panel being connected with a temperature control probe, the mentioned temperature control probe being provided on the bottom surface of the mentioned flexible heat generating film, or the mentioned temperature control probe being connected with the mentioned flexible heat generating body and extending outside the mentioned flexible insulator;
When the mentioned conductive member comprises a first and a second conductor, the mentioned first conductor and the mentioned second conductor are electrically connected to the mentioned temperature control panel, and the mentioned temperature control panel is electrically connected to the mentioned plug by means of a wire; or
when the mentioned conductive member comprises a wireless charging module, the mentioned temperature control panel is provided on the mentioned wireless charging base and electrically connected to the mentioned wireless charging base by wires;
The mentioned temperature control panel is provided with an over-temperature controller, with the mentioned over-temperature controller being contacted with the mentioned flexible heating film.

8. A warm vegetable board as claimed in claim 7, characterized in that the mentioned warm vegetable board further comprises a temperature display screen, with the mentioned temperature display screen being provided on an upper surface of the mentioned temperature control panel;
The mentioned temperature display is electrically connected to the mentioned temperature control panel.
